(19) United States
(12) Patent Application Publication
(10) Pub. No.: US 2013/0289161 A1
(43) Pub. Date: Oct. 31, 2013

(54) Automotive Ceramic Friction Material Free from Asbestos and Metal and Preparation Method Thereof

(71) Applicants: Bowei Liu, Changsha (CN); Meiling Liu, Changsha (CN); Yong Liu, Changsha (CN); Boyun Huang, Changsha (CN)

(72) Inventors: Bowei Liu, Changsha (CN); Meiling Liu, Changsha (CN); Yong Liu, Changsha (CN); Boyun Huang, Changsha (CN)

(73) Assignees: CENTRAL SOUTH UNIVERSITY, Changsha, Hunan (CN); HUNAN BOYUN AUTOMOBILE BRAKE MATERIALS CO., LTD., Changsha, Hunan (CN)

(21) Appl. No.: 13/977,660

(22) PCT Filed: Dec. 30, 2010
(86) PCT No.: PCT/CN2010/002213

§ 371 Date: Jun. 28, 2013

(51) Int. Cl. F16D 69/02

(52) U.S. Cl. CPC F16D 69/026
USPC 523/155; 264/667

(57) ABSTRACT

An automotive ceramic friction material free from asbestos and metal and preparation method thereof are provided. The material includes the following components: organic adhesive, reinforced fiber, friction-increasing agent, antifriction agent and fillers. The material has high coefficient of friction, stable braking performance, low heat fading, low wear resistance and long service life.

### NOTICE OF COPYRIGHT

A portion of the disclosure of this patent document contains material that is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of Invention

The present invention relates to the technology field of friction material applied to a brake plate of the automotive braking system and preparation method thereof, and more particularly to an automotive asbestos-free and metal-free ceramic friction material and the preparation method thereof.

2. Description of Related Arts

Friction materials containing asbestos, being forbidden, have been replaced by semi-metallic friction materials. Currently, low-metal friction materials have become mainstream products in the market. However the use of steel fibers as reinforcement fibers in semi-metallic and low-metal friction materials creates a several product defects. First, steel fibers rust easily, causing damage to the adhesive mating and decreasing the strength of the friction plate, whereupon the abrasion of the friction plate increases and the stability of friction coefficient deteriorates. Secondly, the thermal conductivity of semi-metallic and low-metal friction materials is high, while the semi-metallic and low-metal friction materials are pared off easily, such that the breaking system stops working. Thirdly, utilizing semi-metallic and low metal friction materials tends to generate low frequency noise. In order to solve the above-mentioned problems, it is highly desirable to develop organic friction materials free from asbestos.

Researchers have been unable to find a single type of fiber that has characteristics that can replace the use of steel fibers and asbestos fibers. Therefore, the researchers apply a variety of mixed fibers for combing the mechanical and physical properties of different fibers so as to enhance the frictional properties and performance of the non-asbestos friction materials. In addition, the mixed fibers are environmental friendly and popular in the market. However, the traditional resin non-asbestos, non-steel fibers friction materials utilize mass organic fibers, inorganic fibers having large specific surface areas, and fillers, so that a substantial amount of resin adhesive is needed for good adhesive performance. Therefore, the traditional resin friction material has poor heat fading resistance performance. The coefficient of the friction of the materials decreases depending on the proportion of non-steel fibers added therein. Seriously, abrasion and heat fading problems result from the utilization of more friction-increasing fillers. Hence, given the foregoing problems, it is important to improve the properties of friction materials that are free from asbestos and steel fibers.

### SUMMARY OF THE PRESENT INVENTION

A main object of the present invention is to provide an automotive ceramic friction material free from asbestos and metal and preparation method thereof having high coefficient of friction, stable braking performance, low heat fading, low wear resistance and long service life.

According to the first preferred embodiment of the present invention, an automotive ceramic friction material, free from asbestos and steel fibers comprises the constituents of organic adhesive, reinforced fiber, friction-increasing agent, anti-friction agent, and fillers, wherein the weight percentage of organic adhesive is between 3% and 8%, the weight percentage of reinforced fiber is between 20% and 45%, the weight percentage of friction-increasing agent is between 3% and 12%, the weight percentage of antifriction agent is between 15% and 25%, and the weight percentage of fillers is between 10% and 30%. The sum of the weight percentage of all constituents is 100%.

As mentioned above, the organic adhesive can be one of phenolic resin and acrylonitrile-butadiene rubber, wherein the particle size of the phenolic resin is between 180 and 200 meshes, wherein the particle size of acrylonitrile-butadiene rubber is between 20 and 40 meshes.

Accordingly, the reinforced fiber must be at least two constituents of metal fibers, selected from the group consisting of copper fibers, aramid fiber, carbon fibers, mineral fibers, alumina fibers, and scaly potassium titanate, wherein the diameter of copper fibers is between 100 and 150 micron, wherein the diameter of aramid fibers and carbon fibers are less than 5 micron, and the length of aramid fibers and carbon fibers are between 300 and 80 micron, wherein the diameter of alumina fibers is between 120 and 180 micron, wherein the particle size of scaly potassium titanate is between 40 and 80 micron and the surface of the scaly potassium titanate is processed by the silane coupling agent.

Accordingly, the friction-increasing agent can be zirconium quartz, wherein the particle size of the zirconium quartz is between 30 and 50 micron. Besides, the zirconium quartz is soaked in the concentration of 60%˜80% of aluminum-chromium phosphate solution, and then the zirconium quartz is baked at the temperature between 200° C. and 500° C. for 1 to 3 hours so that the aluminum-chromium phosphate is coated on the surface of the zirconium quartz.

Accordingly, the anti-friction agent is a mixture including at least one of the antimony trisulfide and graphite, and the tin-sulfur-copper composite, wherein the anti-friction agent includes 10%˜40% weight percentage of the tin-sulfur-copper composite, wherein the particle size of the antimony trisulfide and graphite are between 40 and 74 micron, wherein the particle size of the tin-sulfur-copper composite is between 30 and 50 micron.

Accordingly, the fillers can be one of calcium carbonate and barium carbonate, wherein the particle size of calcium carbonate and barium carbonate are between 100 and 150 micron.

According to the second preferred embodiment of the present invention, a method of preparing an automotive ceramic friction material free from asbestos and steel fibers, comprises the steps of:

(1) preparing and mixing the constituents for the automotive ceramic friction material free from asbestos and steel fibers according to the pre-designed weight percentage so as to provide a mixture;

(2) heat molding the mixture in a pressuring mold at the pressure force between 200 and 500 kgf/cm², the heating temperature between 160 and 200° C., the gas exhausting time between 3 and 8 times, and the ratio between time, thickness, and pressure between 60 and 75 second per millimeter calculating from the thickness of the mixture, so as to provide a molded mixture;

(3) heat processing the molded mixture according to the heating rate of 112° C. per minutes until temperature is at 140° C. and maintained for one hour, after that increasing the temperature continuously to 160˜180° C. for heat preserving for 4 hours, and then the temperature continuously increases depending on the heating rate of 0.5˜1° C./minutes until the temperature is at 210° C. in order to heat preserve for 4 hours; furthermore the molded mixture is cooled in the room temperature within the pressuring mold so as to provide a heat-processed molded mixture;

(4) heating the heat-processed molded mixture to a temperature between 650˜700° C. in order to process the high-temperature surface-ablation process, and then the heat processed molded mixture cools down within the pressuring mold so as to provide an automotive ceramic friction material, free from asbestos and steel fibers.

According to the above mentioned preferred embodiment, the friction increasing agent, defined as zirconium quartz with the aluminum-chromium phosphate coated thereon, and the anti-friction agent defined as a tin-sulfur-copper composite are defined as a ceramic surface-coating binder. The zirconium quartz is a conventional friction-increasing material, wherein the liquid aluminum-chromium phosphate solution is acidic so that the solidification of the phenolic resin provided from the alkaline catalyst is affected. Therefore, if the zirconium quartz powder is processed to an after-coating high-temperature baking process, the aluminum-chromium phosphate coated on the zirconium quartz will be heated and processed the first dehydration reaction. After the first dehydration reaction of the aluminum-chromium phosphate coated on the zirconium quartz, the acidity of the aluminum-chromium phosphate weakens, so that the network structure of the aluminum-chromium-phosphate-oxygen bond forms to soak the zirconium quartz. When the friction materials and mating plates are used at a temperature above 500° C., the organic adhesive resin rubber is heated to the point of loss of function. Continuously, the friction coefficient starts to decrease, and the recession appears. Therefore, the aluminum-chromium phosphate coated on the zirconium quartz starts to process the secondary cross-linked dehydration reaction. At the same time, the tin-sulfur-copper composite starts to melt so as to adhesively crosslink with the network structure of the aluminum-chromium-phosphate salt. Continuously, the network structure between the tin-sulfur-copper composite and aluminum-chromium-phosphate salt closely crosslinks, so that the friction materials tend to perform ceramic processing. Depending on the good friction performance of the zirconium quartz, the downward trend of the friction coefficient slowly decreases, so that the fading of the friction material declines also. At the same time, the adhesive strength of the friction materials can be maintained at the high temperature, so that the structure of the friction materials is compact. Therefore, the inner adhesive strength of the friction materials can be maintained while decreasing the abrasion loss of those materials under the high temperature.

Moreover, the tin-sulfur-copper composite includes stannic sulfide allay and cuprous sulfide. According to the adhesive characteristic of the melting sulfide at the high temperature, the tin-sulfur-copper composite can simultaneously perform the adhesion and lubrication effect. The surface of the friction plate forms a transfer film between the friction plate and mating plate so as to protect the mating plate during the friction action. Finally, the abrasion between the friction and mating plate efficiently decreases.

Especially, the automotive friction material according to the present invention has no asbestos and steel fibers, so it is harmless to the human body. At the same time, it eliminates the drawbacks of rust damage, mating damage, and braking noise generated from the rusting of the steel fibers. Furthermore, these friction materials provide an environmental friendly solution with excellent working performance.

According to the present invention, the automotive friction materials utilizes large amount of organic fibers, including mineral fibers, carbon fibers, alumina fibers, and scaly potassium titanate, along with the friction-increasing agent zirconium quartz of the organic ceramic adhesive coating so as to enhance the inner-bonding structure and increase the coefficient of friction of the materials. Obviously, this improves the low friction coefficient of the traditional NAO (non-asbestos organic) materials. In addition, when the anti-friction agent tin-sulfur-copper composite is added to the friction materials, the consequent high temperature melting status of the material has the result that the abrasion of the friction materials is more stable. This solves the aforementioned shortcoming of the traditional NAO materials having a short service life due to the high abrasion effects.

According to the preferred embodiment as mentioned above, the automotive ceramic friction material free from asbestos and steel fibers has a high friction coefficient, stable braking performance, low heat fading, low abrasion loss, and long service life. Wherein, compared to the traditional resin friction material free from asbestos and steel fibers, the ceramic friction material free from asbestos and steels fibers has the higher environmental-friendly performance, higher breaking stability, higher heat fading resistance, higher abrasion resistance, lower frequency noise, and no mating damage.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a noise detection FIGURE for a sample provided from experimental group 4. FIG. 1 shows the noise testing for the sample provided from group 4, wherein the noise level is 10 defined as no noise.

### DETAILED DESCRIPTION OF THE PREFERRED EMBODIMENT

Below will combine the preferred embodiment of the present invention, and further illustrate the methodological and compositional principles of the present invention. Six experimental groups are provided to illustrate the preferred embodiment, wherein the numbers of the six experimental groups are respectively 1, 2, 3, 4, 5, and 6. Another two groups, group 7 and group 8 are the control groups.

Accordingly, each example of the six examples utilizes the different proportions of constituents, which are

(1) Adhesive including the phenolic resin having the particle size between 180 and 200 meshes, and the acrylonitrile-butadiene rubber having the particle size of between 20 and 40 meshes.

(2) Reinforced fibers defined as at least two constituents mentioned below, including copper fibers having the diameter between 100 and 150 micron, aramid fiber (Dupont, Kevlar) having the diameter less than 5 micron and the length between 300 and 500 micron, carbon fibers having the diameter of less than 5 micron and the length between 300 and 500 micron, mineral fibers (Lapinus) having a diameter of less than 5 micron and the length between 300 and 800 micron, alumina fibers having the diameter between 120 and 180 micron, and scaly potassium titanate having the particle size between 40 and 80 micron and the surface of the scaly potassium titanate is processed by the silane coupling agent.

(3) Friction-increasing agent defined as zirconium quartz having the particle size between 30 and 50 micron. Besides, the zirconium quartz is soaked in the concentration of 60%˜80% of aluminum-chromium phosphate solution, and then the zirconium quartz is baked at the temperature between 200° C. and 500° C. for 1 to 3 hours so that the aluminum-chromium phosphate is coated on the surface of the zirconium quartz.

(4) Anti-friction agent composed of at least one of the antimony trisulfide and graphite, and the tin-sulfur-copper composite, wherein the anti-friction includes 10%˜40% weight percentage of the tin-sulfur-copper composite, wherein the particle size of the antimony trisulfide and graphite are between 40 and 74 micron, wherein the particle size of the composite of tin, sulfur and copper is between 30 and 50 micron.

(5) Fillers can be one of calcium carbonate having the particle size between 100 and 150 micron and barium carbonate having the particle size between 100 and 150 micron.

The particle size of the friction-increasing agent applying for group 7 and group 8 are between 30 and 50 micron, and the zirconium quartz is with no aluminum-chromium phosphate coated.

Group 1 and group 2 of the present invention apply the following preparation method. According to the pre-design weight percentage of all constituents for the friction materials, a mixture of the constituents is prepared. The mixture is molded in a pressuring mold at the pressure between 200 and 500 kgf/cm², at a temperature between 160 and 200° C., the gas exhausting time between 3 and 8 times, and the ratio of time, thickness, and pressure between 60 and 75 second per millimeter calculated from the thickness of the mixture, so as to provide a molded mixture, after which the molded mixture is heated at the temperature of 140° C. under heating rate of 1˜2° C./minutes and maintaining that heat level for one hour, after that increasing the temperature continuously to 160˜180° C., maintaining that heat level for 4 hours, and then the temperature continuously increases at a the heating rate of 0.5˜1° C./minutes until the temperature is at 210° C. in order to heat and preserve for 4 hours; after which the molded mixture is cooled until the room temperature within the pressuring mold so as to provide a heat processed molded mixture. The heat processed molded mixture is heated to a temperature between 650 and 700° C. in order to process the high-temperature surface-ablation process, where after the heat processed molded mixture is cooled down within the pressuring mold so as to provide an automotive ceramic friction material free from asbestos and steel fibers.

Group 3 and group 4 of the present invention apply the following preparation method. According to the pre-design weight percentage of all constituents for the friction materials, a mixture of the constituents is prepared. The mixture is placed into a pressuring mold at the pressure between 200 and 500 kgf/cm², the temperature between 160 and 200° C., the gas exhausting time between 3 and 8 times, and the ratio of time, thickness, and pressure between 60 and 75 second per millimeter based on the thickness of the mixture, so as to provide a molded mixture; that is then heated to the temperature of 140° C. at a heating rate of 1˜2° C./minutes and maintained for one hour, after that the temperature continuously increases to 160˜180° C. and maintained at that heat level for 4 hours, and then the temperature continuously increases at a heating rate of 0.5˜1° C./minutes up to a temperature of 210° C. in order to heat preserve for 4 hours; after which the molded mixture is cooled to the room temperature within the pressuring mold so as to provide a heat processed molded mixture. The heat processed molded mixture is heated to the temperature between 650 and 700° C. in order to facilitate the high-temperature surface-ablation process, and thereafter the heat processed molded mixture is cooled down within the pressuring mold so as to provide an automotive ceramic friction material free from asbestos and steel fibers.

Group 5 and group 6 of the present invention apply the following preparation method. According to the pre-design weight percentage of all constituents for the friction materials, a mixture is prepared of the constituents. The mixture is placed into a pressuring mold at a pressure between 200 and 500 kgf/cm², a temperature between 160 and 200° C., the gas exhausting time between 3 and 8 times, and the ratio of time, thickness, and pressure between 60 and 75 second per millimeter calculating from the thickness of the mixture, so as to provide a molded mixture, and then the molded mixture is heated to the temperature of 140° C. according to the heating rate of 1˜2° C./minutes for heat preserving for one hour, after that the temperature continuously increases to 160˜180° C. for heat preserving for 4 hours, and then the temperature continuously increases depending on the heating rate of 0.5˜1° C./minutes until the temperature of 210° C. in order to heat preserve for 4 hours; furthermore the molded mixture is cooled until the room temperature within the pressuring mold so as to provide a heat processed molded mixture. The heat processed molded mixture is heated until the temperature between 650 and 700° C. in order to process the high-temperature surface-ablation process, and the heat processed molded mixture is cooled down within the pressuring mold so as to provide an automotive ceramic friction material free from asbestos and steel fibers.

Group 7 and group 8 of the present invention apply the same preparation method as group 3 and group 4.

Table 1 is the weight percentage of all constituents applied for experimental group 1 to group 6, and control group 7 and group 8.

| composition (%) | 1 | 2 | 3 | 4 | 5 | 6 | 7 | 8 |
|---|---|---|---|---|---|---|---|---|
| resin | 8 | 8 | 5 | 5 | 4 | 3 | 5 | 4 |
| aramid fibers | 2 | 2 | 3 | 3 | 3 | 3 | 3 | 3 |
| copper fibers | 0 | 4 | 4 | 4 | 4 | 4 | 4 | 4 |
| carbon fibers | 4 | 0 | 5 | 5 | 6 | 7 | 5 | 5 |
| mineral fibers | 25 | 25 | 30 | 25 | 25 | 25 | 25 | 25 |
| alumina fibers | 0 | 3 | 10 | 3 | 3 | 3 | 3 | 3 |
| scaly potassium | 10 | 14 | 0 | 10 | 10 | 10 | 10 | 10 |
| titanate | | | | | | | | |
| coated zirconium | 3 | 5 | 7 | 9 | 10 | 12 | 0 | 0 |
| quartz | | | | | | | | |
| zirconium quartz | 0 | 0 | 0 | 0 | 0 | 0 | 5 | 7 |
| tin-sulfur-copper | 3 | 4 | 5 | 7 | 8 | 10 | 5 | 7 |
| composite | | | | | | | | |
| antimony trisulfide/ | 15 | 15 | 15 | 15 | 15 | 15 | 15 | 15 |
| graphite | | | | | | | | |
| fillers | 29 | 20 | 18 | 14 | 12 | 8 | 20 | 17 |

According to the experimental group 1 to 6, the coated zirconium quartz with the aluminum-chromium phosphate coated thereon has a weight percentage between 3% and 12%, and the tin-sulfur-copper composite has a weight percentage of 3% and 10%. The zirconium quartz utilized by the control group 7 and group 8 have no aluminum-chromium phosphate coated. All of the constituents are uniformly mixed to manufacture a friction plate according to the preparation method of the preferred embodiment of the present invention, wherein the friction plate applied to the Honda Accord D 465 model is an example for the present invention.

Accordingly, each of the friction plate manufactured from the experimental groups are respectively processed the following tests, wherein a bench testing machine and a loading data collection system of NVH3900 manufactured by LINK are applied for testing the following performance:

(1) Fading Performance (SAE J2522, AK master, 100 km/h, 0.4 g deceleration rate)

(2) Braking Efficiency (SAE J2522, AK master, 80 km/h, 160 km/h, 200 km/h). Table 3 illustrates the data of the fading performance and braking efficiency.

(3) Noise Performance (SAE J2521)

(4) Abrasion Performance (SAE 2702) Wherein, table 2 illustrates the testing condition of the abrasion performance (SAE 2702)

As shown in table 3, with an increased content of the aluminum-chromium phosphate composite salt coated on the zirconium quartz, the friction coefficient of the friction material has an upward tendency, wherein group 2 to group 6 have the best braking stability, the friction coefficient of group 3 and group 4 are high and stable so that the fading of group 3 and group 4 are relatively small. The friction coefficient of group 5 and group 6 are so high as to cause other problems. The control group 7 and group 8 have the same content of zirconium quartz as group 3 and group 4, but the zirconium quartz are not aluminum-chromium phosphate composite salt coated. Therefore, the friction coefficient of group 7 and group 8 are relatively lower than group 4 and group 3, so that the stability of group 7 and group 8 are relatively poor, and the fading of group 7 and group 8 are relatively strong. Depending on the degree of increased content of the aluminum-chromium phosphate composite salt coated on the zirconium quartz, the friction coefficient of the friction material has an upward tendency, and the abrasion loss, also, is relatively in an upward tendency. In addition, if the ratio of the composite salt of the zirconium quartz is larger than 1.2, the abrasion loss is in an upward tendency.

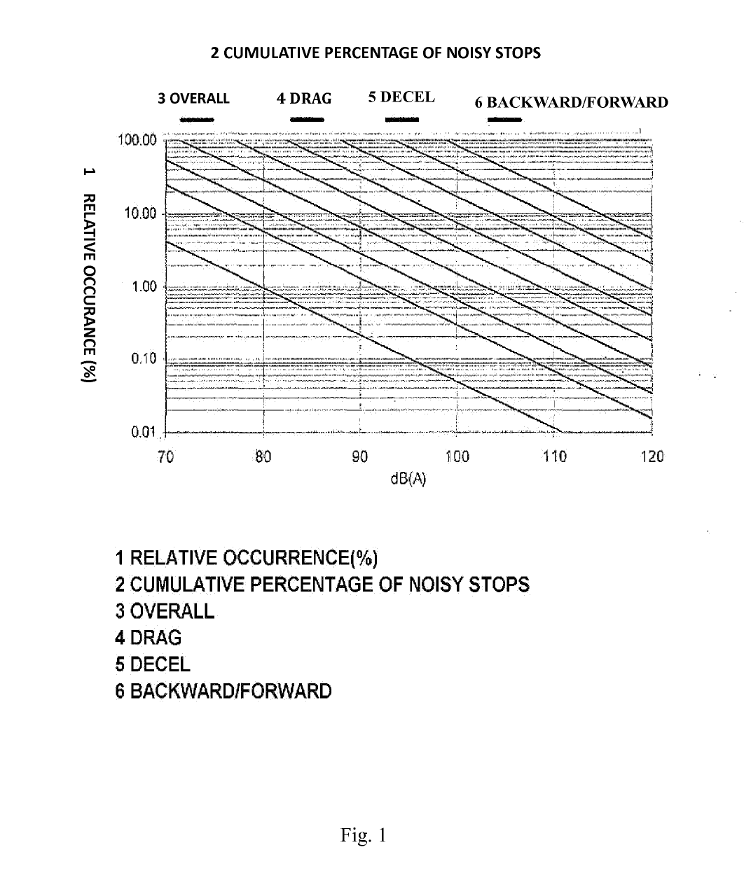

As shown in FIG. 1 shows the noise testing for the sample provided from group 4, wherein the noise level is 10 defined as no noise

TABLE 2

| | | | | Braking | Braking |
|---|---|---|---|---|---|
| | Initial | Final | Initial Disc | decel- | Fre- |
| | Velocity | Velocity | Temperature | eration | quency |
| Parts | (km/h) | (km/h) | (° C.) | (g) | (N) |
| Run-in | 50 | 4 | 100 | 0.25 | 100 |
| Urban Road 1 | 50 | 4 | 150 | 0.25 | 200 |
| (TB)1 | | | | | |
| Country Road | 80 | 4 | 200 | 0.35 | 200 |
| 1 (CB)1 | | | | | |
| Country Road | 100 | 4 | 125 | 0.40 | 200 |
| 2 (CB)2 | | | | | |
| Urban Road | 50 | 4 | 150 | 0.25 | 200 |
| 2 (TB)2 | | | | | |
| Country | 100 | 4 | 125 | 0.40 | 200 |
| Road 3 (CB)3 | | | | | |
| Pathway | 80 | 4 | 350 | 0.35 | 50 |
| (HDB) | | | | | |

TABLE 3

| | | | | | Abrasion(SAE |
|---|---|---|---|---|---|
| SAE | | | | Fading rate | 2707, one |
| J2522 | 80 km/h | 160 km/h | 200 km/h | (min) | circle) |
| 1 | 0.36 | 0.32 | 0.28 | 0.20 | 0.97 |
| 2 | 0.38 | 0.35 | 0.32 | 0.23 | 0.82 |
| 3 | 0.40 | 0.38 | 0.38 | 0.26 | 0.65 |
| 4 | 0.42 | 0.40 | 0.42 | 0.30 | 0.58 |
| 5 | 0.44 | 0.43 | 0.42 | 0.31 | 0.77 |
| 6 | 0.45 | 0.43 | 0.43 | 0.33 | 0.93 |
| 7 | 0.37 | 0.33 | 0.30 | 0.19 | 0.89 |
| 8 | 0.40 | 0.36 | 0.34 | 0.24 | 1.13 |

What is claimed is:

1. An automotive ceramic friction material free from asbestos and steel fibers, including:
an organic adhesive having a weight percentage between 3% and 8%;
reinforced fibers having a weight percentage between 20% and 45%;
a friction-increasing agent having a weight percentage between 3% and 12%;
an antifriction agent having a weight percentage between 15% and 25%; and
fillers having a weight percentage between 10% and 30%; wherein a sum of a weight percentage of the automotive ceramic friction material is 100%.

2. The automotive ceramic friction material free from asbestos and steel fibers, as recited in claim 1, wherein said organic adhesive is one of phenolic resin and acrylonitrile-butadiene rubber, wherein a particle size of the phenolic resin is between 180 and 200 meshes, wherein a particle size of acrylonitrile-butadiene rubber is between 20 and 40 meshes.

3. The automotive ceramic friction material free from asbestos and steel fibers, as recited in claim 2, wherein said reinforced fibers includes at least two constituents selected from a group consisting of copper fibers, aramid fiber, carbon fibers, mineral fibers, alumina fibers, and scaly potassium titanate, wherein a diameter of said copper fibers is between 100 and 150 micron, wherein a diameter of said aramid fibers and carbon fibers is less than 5 micron, and a length of said aramid fibers and said carbon fibers is between 300 and 80 micron, wherein a diameter of said alumina fibers is between 120 and 180 micron, wherein a diameter of said scaly potassium titanate is between 40 and 80 micron and a surface of the said scaly potassium titanate is processed by a silane coupling agent.

4. The automotive ceramic friction material free from asbestos and steel fibers, as recited in claim 3, wherein said friction-increasing agent is zirconium quartz, wherein a particle size of said zirconium quartz is between 30 and 50 micron, wherein said zirconium quartz is soaked in the concentration of 60%˜80% of aluminum-chromium phosphate solution, and then said zirconium quartz is baked at the temperature between 200° C. and 500° C. for 1 to 3 hours so that said aluminum-chromium phosphate is coated on the surface of the zirconium quartz.

5. The automotive ceramic friction material free from asbestos and steel fibers, as recited in claim 4, wherein said anti-friction agent is a mixture including at least one of antimony trisulfide and graphite, and tin-sulfur-copper composite, wherein said anti-friction includes 10%˜40% weight percentage of said tin-sulfur composite, wherein a particle size of said antimony trisulfide and said graphite is between 40 and 74 micron, wherein a particle size of said tin-sulfur-copper composite is between 30 and 50 micron.

6. The automotive ceramic friction material free from asbestos and steel fibers, as recited in claim 5, wherein said fillers are one of calcium carbonate and barium carbonate, wherein a particle size of said calcium carbonate and said barium carbonate is between 100 and 150 micron.

7. A method of preparing an automotive ceramic friction material free from asbestos and steel fibers as recited in claim 1, comprising the steps of:
(a) preparing and mixing constituents for said automotive ceramic friction material free from asbestos and steel fibers according to the pre-design weight percentage;
(b) heat molding said mixture in a pressuring mold at the pressure between 200 and 500 kgf/cm², the temperature between 160 and 200° C., the gas exhausting time between 3 and 8 times, and the ratio of time, thickness, and pressure between 60 and 75 second per millimeter calculated from the thickness of said mixture, so as to provide a molded mixture;
(c) heat processing said molded mixture according to the heating rate of 1˜2° C./minutes to 140° C. for heat preserving for one hour, after that the temperature continuously increasing to 160˜180° C. for heat preserving for 4 hours, and then the temperature continuously increases depending on the heating rate of 0.5˜1° C./minutes until the temperature of 210° C. in order to heat preserve for 4 hours; furthermore the molded mixture is cooled in the room temperature within the pressuring mold so as to provide a heat processed molded mixture; and
(d) heating said heat processed molded mixture to 650˜700° C. in order to produce high-temperature surface-ablation process, and then cooling said heat processed molded mixture within the pressuring mold so as to provide said automotive ceramic friction material free from asbestos and steel fibers.
